(19) United States
(12) Patent Application Publication
(10) Pub. No.: US 2021/0399549 A1
(43) Pub. Date: Dec. 23, 2021

(54) Apparent Power Management in Hybrid Power Stations

(71) Applicant: General Electric Renovables España, S.L., Barcelona (ES)

(72) Inventors: Andreu Casal Vilana, Barcelona (ES); Veena Padmarao, Bangalore (IN); Igor Berroteran Gil, Salem, VA (US); Patrick Hart, Schenectady, NY (US)

(21) Appl. No.: 17/281,193

(22) PCT Filed: Sep. 27, 2019
(86) PCT No.: PCT/US2019/053354

§ 371 Date: Mar. 29, 2021

(30) Foreign Application Priority Data
Sep. 27, 2018 (IN) 201841036544

(51) Int. Cl. H02J 3/16; H02J 3/38; H02J 3/46; H02S 10/12

(52) U.S. Cl. CPC H02J 3/16; H02J 3/381; H02J 2300/26; H02S 10/12; H02J 2300/28; H02J 3/466

(57) ABSTRACT

A hybrid power system (100) comprising a wind turbine (102) having a wind turbine generator and a power converter, and one or more DC power sources (104). The hybrid power system is configured to prioritize active power output over reactive power capability when the wind turbine is not operating, and is further configured to prioritize reactive power capability over active power output when the wind turbine is operating and wind speed is above a predetermined threshold. Methods for operating a hybrid power system are also provided.

### FIELD

The present disclosure relates to managing apparent power production in hybrid power systems. More particularly, the present disclosure relates to managing apparent power production and capability in a power system involving a wind turbine and a DC power source.

### BACKGROUND

Renewable energy sources, such as wind and solar energy receive increasing attention from the public at large to deliver electrical power to the electrical grid. Such renewable energy sources are reliant on an inherently variable energy supply. For solar panels, the electrical power production will be higher during the day than during the night. For wind turbines the power production may also vary throughout the day and throughout the year.

When a relatively high proportion of electrical power delivered to an electrical power grid comes from renewable energy sources, it becomes increasingly important to manage the variability of the power production.

Modern wind turbines for example are commonly used to supply electricity into the electrical grid. Wind turbines of this kind generally comprise a tower and a rotor arranged on the tower. The rotor, which typically comprises a hub and a plurality of blades, is set into rotation under the influence of the wind on the blades. Said rotation generates a torque that is normally transmitted through a rotor shaft to a generator, either directly (“directly driven”) or through the use of a gearbox. This way, the generator produces electricity which can be supplied to the electrical grid.

Wind turbines and other power sources may be connected to the electrical grid through a power converter which adapts the generated power to the electrical grid and may also provide electricity to the (wind turbine) generator and to an extent control the generator, particularly the generator torque. The electrical power generated by the generator may not be adapted to the electrical grid e.g. in terms of phase angle and frequency. The power converter may be configured to convert the power generated in the generator to electrical power that can be delivered to the grid.

Photovoltaic solar panels absorb sunlight as a source of energy to generate electricity. A photovoltaic (PV) module is a packaged, connected assembly of solar cells. A single solar module can produce only a limited amount of power; most installations contain multiple modules. A photovoltaic system typically includes an array of photovoltaic modules, a DC/AC inverter, interconnection wiring, and may also include a battery pack for storage, and optionally a solar tracking mechanism.

In some locations, it may be found that wind speed is relatively high during the night as compared to the day. By combining solar panels with wind turbines, a more constant power output may be obtained. During the day, the solar panels will produce a higher electrical power, whereas the output from the wind turbines may be lower than during the night because of relatively low wind speed. During the night clearly the solar panels' power output will be down.

The combination of a number of solar panels with a wind turbine can in these circumstances be interesting to make the power output of the combined system less variable and more reliable.

An alternative or complementary way to make a power system more constant in terms of its output is to combine it with an energy storage, for example a battery. In an example, a wind turbine may be combined with a battery or string of batteries. When the wind turbine is generating more power than is requested from the electrical grid, the energy may be stored in the energy storage. The energy that is stored may be used at a later stage when there is an increase in demand. It is known e.g. to electrically couple a battery or a battery string to a DC link of the power converter. The power converter arranged between the renewable power generator and the electrical grid can, dependent on electrical grid demands, and dependent on renewable power supply control the converter to divert DC power to the energy storage, or to divert DC power from the energy storage to the DC link.

A hybrid power station may herein be understood as a combination of a wind turbine and another power source, particularly another DC power source. Such a DC power source may be a battery or string of batteries, but could also be number of solar panels.

Hybrid power stations which are constituted by a combination of a wind turbine, and a predetermined area of solar panels have been offered commercially.

With an increased use of renewable power sources to supply electricity to the grid, the conditions under which the renewable power sources may be connected can become more stringent. Such conditions may be defined in a grid code, and the conditions may include specific capacity or capability to support the grid and/or specific behavior in the case of a grid problem.

In order to support the frequency of the grid, wind turbines (or other renewable power sources) may be expected to provide predetermined active power capability. In order to support the grid voltage, wind turbines (or other renewable power sources) may be expected to provide specific reactive power capability. Depending on the generator and converter configuration, reactive power capability may be provided by the wind turbine generator and also by the converter connected to the wind turbine.

Hybrid power stations provide new challenges in terms of reactive and active power and apparent power management and capability. Apparent power is the product of the root mean square values of voltage and current. Apparent power is conventionally expressed in volt-amperes (VA) since it is the product of root mean square voltage and root mean square current. The unit for reactive power is expressed as var, which stands for volt-ampere reactive.

### BRIEF DESCRIPTION

In one aspect, a hybrid power system is provided. The hybrid power system comprises a wind turbine having a wind turbine generator and a power converter, and one or more DC power sources. The hybrid power system is configured to prioritize active power output over reactive power output when the wind turbine is not operating, and is further configured to prioritize reactive power output over active power output when the wind turbine is operating.

“Prioritizing” as used herein and as used throughout the present disclosure is meant to refer to a selection of either reactive or active power or to a selection of power from one source or another in circumstances wherein, because of the characteristics of the components of the system or characteristics of the system as a whole, not all power demands can be met or not all power supply can be handled.

In accordance with this aspect, a hybrid power system is provided which can be cost-effective and provide adequate support to an electrical grid. In conditions wherein wind power is available and delivered to the grid, reactive power capability may be higher than when the wind turbine is not operating. In order to support the grid, a predetermined reactive power capability may be guaranteed and delivered in accordance with a grid demand, particularly to stabilize grid voltage.

When the wind turbine is not operating, active power delivered to the grid from the DC power sources is prioritized in order to support the grid and ensure frequency control of the grid. Such a system may be particularly useful in the case of a potentially instable grid, e.g. a grid with limited interconnections to other grid which is therefore sensitive to active power changes.

In a further aspect, a method for operating a hybrid power system comprising a wind turbine and one or more DC power sources is provided. The method comprises operating the wind turbine to deliver active power to an electrical grid, operating the one or more DC power sources to deliver active power to the electrical grid, and curtailing the active power delivered to the grid to meet a reactive power demand, if wind speed is within a predetermined operational range of the wind turbine. The method further comprises operating the one or more DC power sources to deliver active power to the electrical grid and curtailing a reactive power capability, if wind speed is not within the predetermined operational range of the wind turbine.

In accordance with this method, active power delivery to the grid may be curtailed when the wind turbine is operating within the predetermined operational range. A total operational range of a wind turbine may range from a cut-in wind speed to a cut-out wind speed. The predetermined operational range for potentially curtailing active power delivery may correspond to the total operational range or only a portion thereof. When the wind turbine is not operating, or in case of relatively low wind speeds, reactive power demands may not always be met, instead active power delivery is maximized.

In yet a further aspect, a method of operating a hybrid power station comprising a wind turbine and a plurality of solar panels is provided. The method comprises operating the solar panels to deliver maximum power to an electrical grid when the wind turbine is not operating, and reducing reactive power capability of the hybrid power station when the maximum power from the solar panels reaches a predetermined threshold.

### BRIEF DESCRIPTION OF THE DRAWINGS

Non-limiting examples of the present disclosure will be described in the following, with reference to the appended drawings, in which:

FIG. 1 illustrates a perspective view of a wind turbine according to one example;

FIG. 2 illustrates a simplified, internal view of a nacelle of a wind turbine according to one example; and

FIG. 3 schematically illustrates an example of a hybrid power station;

FIG. 4 is a flow diagram of a method for operating a hybrid power station comprising a wind turbine and one or more power sources according to one example;

FIG. 5 may serve to illustrate apparent power capabilities in different operating conditions in an example according to the present disclosure; and

FIG. 6 is a flow diagram of a method for operating a hybrid power station comprising a wind turbine and a plurality of solar panels according to one example.

### DETAILED DESCRIPTION

In these figures the same reference signs have been used to designate matching elements.

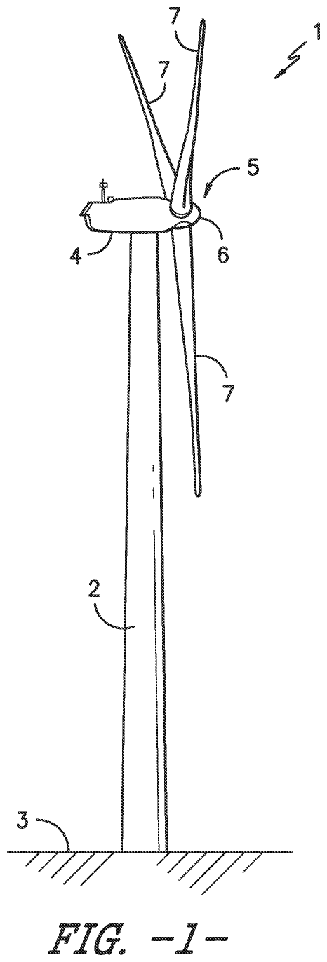

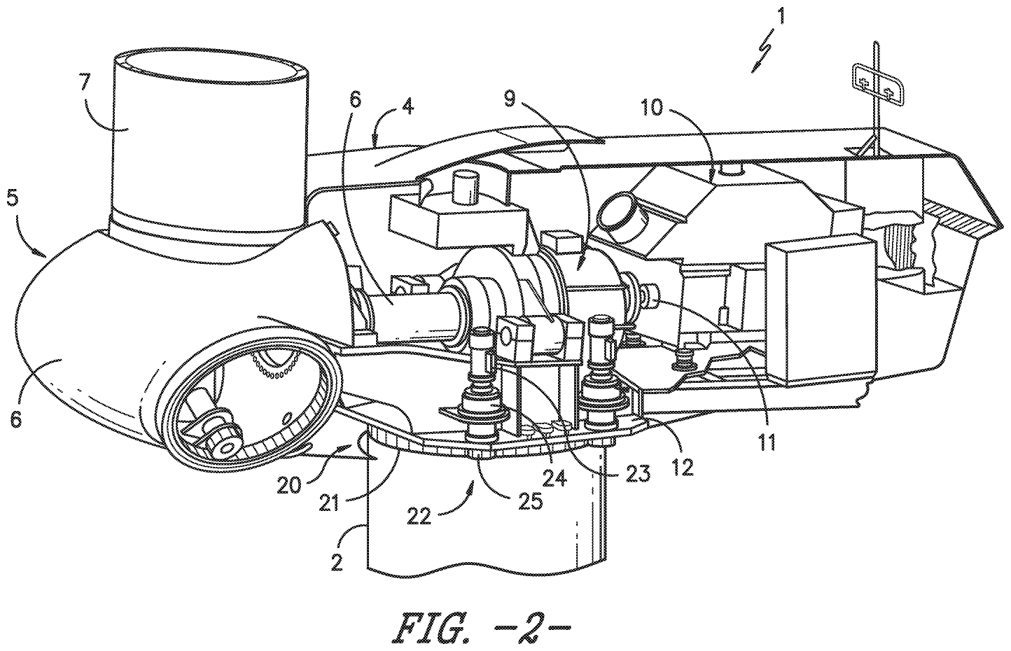

FIG. 1 illustrates a perspective view of one example of a wind turbine 1. As shown, the wind turbine 1 includes a tower 2 extending from a support surface 3, a nacelle 4 mounted on the tower 2, and a rotor 5 coupled to the nacelle 4. The rotor 5 includes a rotatable hub 6 and at least one rotor blade 7 coupled to and extending outwardly from the hub 6. For example, in the illustrated example, the rotor 5 includes three rotor blades 7. However, in an alternative embodiment, the rotor 5 may include more or less than three rotor blades 7. Each rotor blade 7 may be spaced from the hub 6 to facilitate rotating the rotor 5 to enable kinetic energy to be transferred from the wind into usable mechanical energy, and subsequently, electrical energy. For instance, the hub 6 may be rotatably coupled to an electric generator 10 (FIG. 2) positioned within the nacelle 4 or forming part of the nacelle to permit electrical energy to be produced.

FIG. 2 illustrates a simplified, internal view of one example of the nacelle 4 of the wind turbine 1 of the FIG. 1. As shown, the generator 10 may be disposed within the nacelle 4. In general, the generator 10 may be coupled to the rotor 5 of the wind turbine 1 for generating electrical power from the rotational energy generated by the rotor 5. For example, the rotor 5 may include a main rotor shaft 8 coupled to the hub 6 for rotation therewith. The generator 10 may then be coupled to the rotor shaft 8 such that rotation of the rotor shaft 8 drives the generator 10. For instance, in the illustrated embodiment, the generator 10 includes a generator shaft 11 rotatably coupled to the rotor shaft 8 through a gearbox 9.

It should be appreciated that the rotor shaft 8, gearbox 9, and generator 10 may generally be supported within the nacelle 4 by a bedplate or a support frame 12 positioned atop the wind turbine tower 2.

The nacelle 4 is rotatably coupled to the tower 2 through a yaw system 20. The yaw system comprises a yaw bearing (not visible in FIG. 2) having two bearing components configured to rotate with respect to the other. The tower 2 is coupled to one of the bearing components and the bedplate or support frame 12 of the nacelle 4 is coupled to the other bearing component. The yaw system 20 comprises an annular gear 21 and a plurality of yaw drives 22 with a motor 23, a gearbox 24 and a pinion 25 for meshing with the annular gear for rotating one of the bearing components with respect to the other.

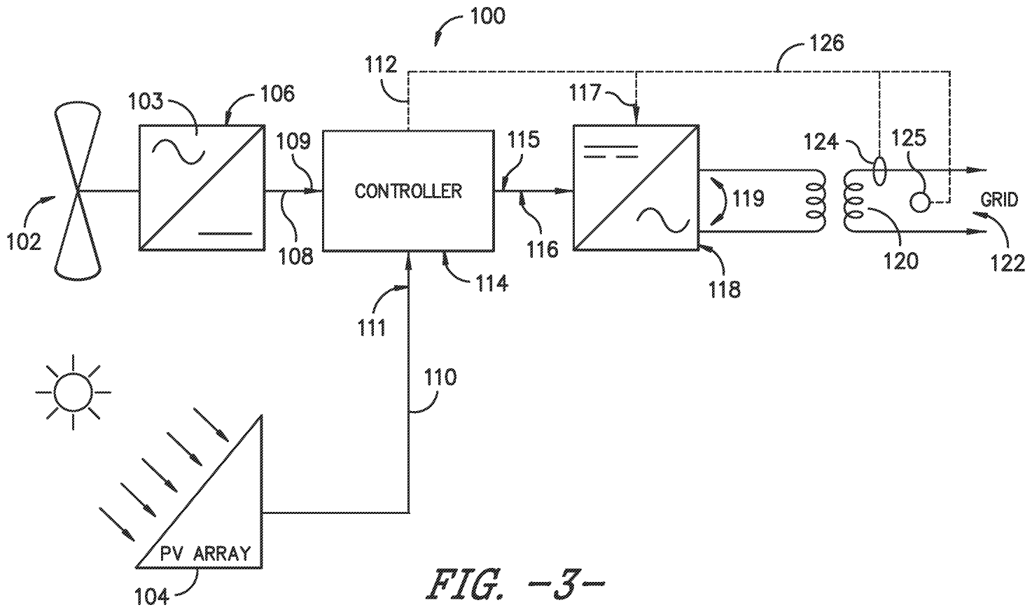

FIG. 3 is a block diagram of an example of a hybrid power station 100 that may simultaneously combine and direct electrical power generated from a wind turbine 102 and/or a solar panel or photovoltaic (PV) array 104 connected to a single output inverter 118 for coupling to an electrical grid 122.

In this example, the AC power 103 generated by the wind turbine 102 may be converted and/or transformed to DC by a rectifier 106, and the resulting DC wind power signal 108 may be in communication with the controller 114 via a first DC power input terminal 109.

In addition, a DC solar power signal 110 may be provided by a PV array 104 and may be in communication with the controller 114 via a second DC power input terminal 111. The controller 114 may direct the aggregated DC power 116 from both the wind and solar sources to an output inverter 118 via output terminal 115. The output inverter 118 may transform and/or convert the aggregated DC power signal 116 to an AC output power signal 119 for coupling to the electrical grid 122. The AC output power signal 119 may be connected the electrical grid 122 directly, or via an optional output transformer 120 as shown in FIG. 1.

In an example of operation, the output inverter 118 may receive one or more electrical grid signals 126 from a grid current sensor 124 and/or a grid voltage sensor 125 at terminal 117, and may utilize the electrical grid signals 126 to synchronize and/or commutate the AC output power signal 119 at the appropriate voltage amplitude, phase, VAR, and/or frequency appropriate for coupling power to the electrical grid 122. The electrical grid signals 126 may also be received at terminal 112 and may be utilized at the controller 114 for directing power signals.

A hybrid power system or station including a wind turbine and solar panels may thus function as a unit. I.e. there is no independent solar system and an independent wind turbine. Control over the unit as a whole may be simplified and improved, and no separate DC/DC converter for the solar panels is needed.

According to a first aspect, a hybrid power system comprising a wind turbine 102 having a wind turbine generator (not shown in the figure) and a power converter 103, (106, 118), and one or more DC power sources is provided. In this example, the DC power sources may be solar panels 104. Alternatively or complementary to the solar panels, batteries and/or fuel cells could be provided as DC power sources.

In accordance with this aspect, the hybrid power system is configured to prioritize active power output over reactive power capability when the wind turbine is not operating, and is further configured to prioritize reactive power capability over active power output when the wind turbine is operating and wind speed is above a predetermined threshold.

In some examples, the predetermined threshold may be a cut-in wind speed. A total operational range of operation of a wind turbine may be from approximately 3 m/s to approximately 25 m/s. The threshold in this example may be set to 3 m/s as well. In these examples, the prioritization of reactive power occurs as soon as the wind turbine is operating. In other examples, the predetermined threshold may be higher than a cut-in wind speed. For example, it could be set to 5 or 6 or 7 m/s. In this case, the prioritization of reactive power does not always occur when the wind turbine is operating, but rather only if the prevailing wind speed is above a minimum threshold. The wind turbine should thus have a power output above a threshold level.

In some examples, the hybrid power system is further configured to prioritize active power output of the wind turbine over the active power output from the DC power sources. This means that if active power delivery is to be curtailed in case of a reactive power demand from the grid, the wind turbine operation is in principle not modified, but rather the DC sources may be controlled such that less active power is generated or delivered. Control over the DC sources may be quicker and simpler than control over a wind turbine of considerable size, and with significant inertia when operating.

In some examples, the hybrid power system may be connected to an electrical grid. In some of these examples, a main transformer may be arranged to connect the hybrid power system to the electrical grid. In some examples, the limitations of the main transformer may be the driver of the prioritization. I.e. it is the main transformer that cannot handle an apparent power combination of DC power being generated and a reactive power demand coming from the grid.

In some examples, the wind turbine generator and the power converter both have reactive power capability. Depending on the generator topology and converter topology, both may have reactive power capability. However, if the wind turbine is not operating, and the wind turbine generator is therefore inoperative, the reactive power capability of the hybrid power station may be significantly reduced. As a result, reactive power demands may not always be met when active power delivery is prioritized for stability of the grid.

In some examples (such as the example of FIG. 3), the wind turbine and the one or more power sources are electrically coupled by the power converter.

In a further aspect, a method for operating a hybrid power system comprising a wind turbine and one or more DC power sources is provided.

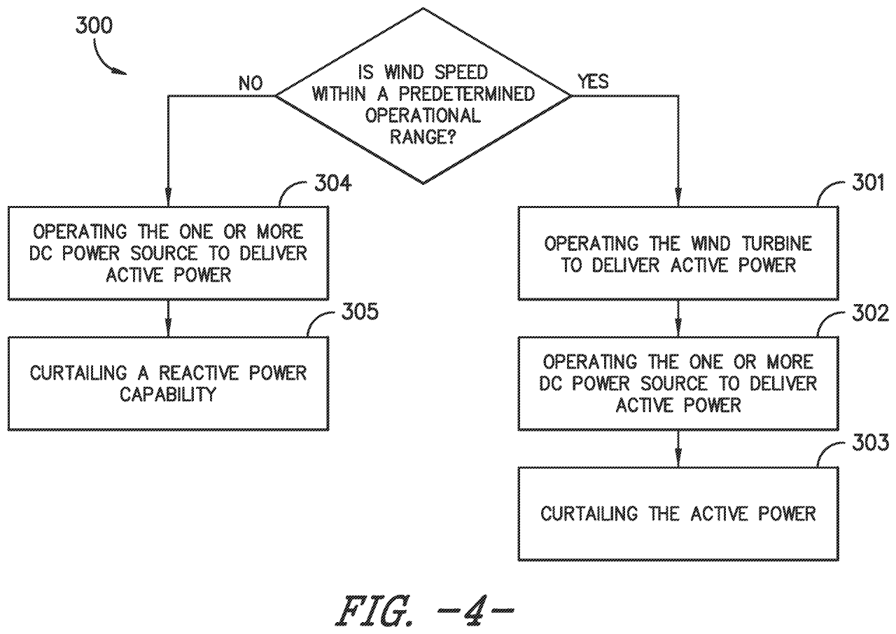

FIG. 4 is a flow diagram of a method 300 for operating a hybrid power station comprising a wind turbine and one or more power sources according to one example. The method 300 comprises: if wind speed is within a predetermined operational range of the wind turbine, then the wind turbine is operated 301 to deliver active power to an electrical grid, the one or more DC power sources are operated 302 to deliver active power to the electrical grid, and the active power delivered to the grid is curtailed 303 to meet a predetermined reactive power demand if apparent power limits are exceeded.

If wind speed is not within the predetermined operational range of the wind turbine, then the one or more DC power sources are operated 304 to deliver active power to the electrical grid and reactive power capability is curtailed 305.

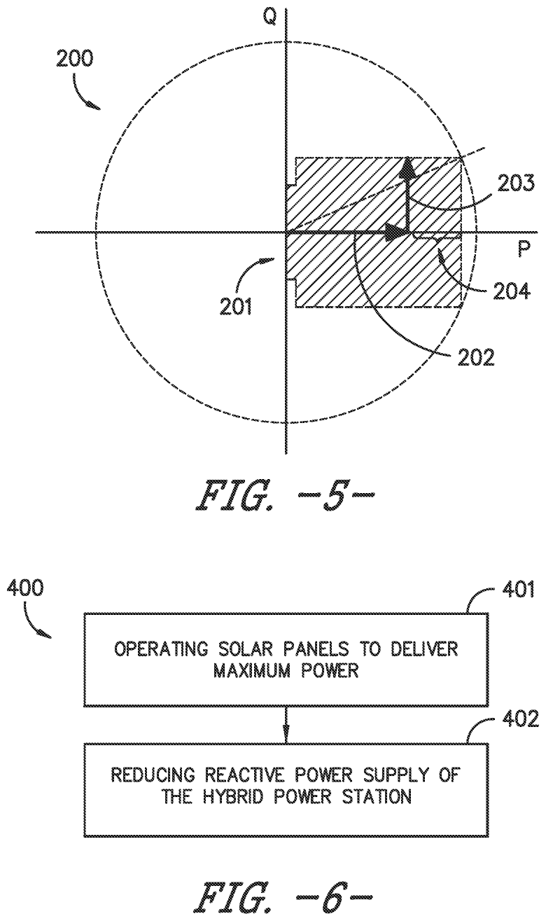

This method may be further illustrated with reference to FIG. 5.

The amount of active and reactive power an electrical component can deliver may be illustrated in a PQ diagram. Depending on the generator topology and characteristics, it may not be possible for the generator to provide rated reactive power supply in case of high active power outputs. It is known that some generators may need to reduce active power production in order to cope with a specific reactive power demand.

Other generators may be able to supply a maximum (rated) reactive power demand regardless of whether it is operating at nominal power, or e.g. at partial load. However, when the generator is not operating at all, the generator may not have reactive power capability, and the only reactive power capability may come from the power converter and main transformer.

FIG. 5 illustrates a PQ diagram 200 for one of the components, the power converter. The hatched area 201 in the diagram corresponds to the operational capabilities of the converter. The active power production from the wind turbine is indicated with a first arrow 202. A reactive power demand or guaranteed capability is indicated with a second arrow 203. Under these circumstances, the amount of active power that the converter is still able to handle is indicated with 204.

That amount of active power may be delivered from a variety of DC sources, including e.g. batteries or ultracaps, or fuel cells or solar panels. In a system such as the system disclosed in FIG. 3, it may happen that a high amount of solar power is available, but the apparent power limitations of the system would be exceeded. Curtailing of the active power thus becomes necessary.

In some examples, curtailing the active power delivered to the grid to maintain a predetermined reactive power capability comprises curtailing the active power delivered by the one or more DC power sources.

Specifically, in some examples curtailing the active power delivered to the grid comprises storing a part of the active power delivered by the hybrid power station in an energy storage, e.g. a battery. Alternatively or complementary hereto curtailing the active power delivered to the grid comprises dissipating a part of the active power delivered by the hybrid power station. Dissipating part of the active power may include passing the current through a resistive load. Alternatively or complementary hereto, the DC power sources may be controlled to generate less active power. E.g. in the case of a solar panel, it may be directed to capture less irradiation.

In some examples, if the active power delivered from the DC power sources has been reduced to zero, and active power still needs to be further reduced, the active power delivered by the wind turbine may be curtailed as well.

In a further aspect, a method of operating a hybrid power station comprising a wind turbine and a plurality of solar panels is provided.

FIG. 6 is a flow diagram of a method 400 for operating a hybrid power station comprising a wind turbine and a plurality of solar panels according to one example. The method 400 comprises operating 401 the solar panels to deliver maximum power to an electrical grid when the wind turbine is not operating, and reducing 402 reactive power supply of the hybrid power station when the maximum power from the solar panels reaches a predetermined threshold.

In order to avoid having to increase performance and characteristics of several electric components such as the main transformer and/or power converter (and thereby keep cost of the hybrid power station under control) and in order to provide stability to the grid, priority may be given to active power production at the expense of reactive power supply, particularly in the case of low total active power production.

Active power supply may be particularly significant in grids with limited interconnection and also in grids with a large proportion or renewable power supply.

In case of higher active power production i.e. the wind turbine is operating and wind speed is above a threshold level, reactive power may be prioritized since sufficient active power is already delivered to the grid. The switch of prioritization can serve to increase stability of the electrical grid.

One further way to implement the methods and systems disclosed herein will be described.

It is known to group a plurality of wind turbines together in a wind park. Similarly, the herein described hybrid power machines may be grouped together in a park. The hybrid power machines in a park deliver power to a local park grid, and the park is connected to the electrical grid at a point of common coupling (PCC).

A park may include a park controller that provides a high level control of the active and reactive power output of the park. The amount of active and/or reactive power output may be measured at the PCC and compared to the grid demand. The grid demand may be received from a grid operator, or may be determined in response to e.g. a measurement of current and voltage at the PCC.

Each of the individual hybrid machines further includes a local controller that can communicate with the wind park controller. The park controller may send active or reactive power demands to the individual local controllers. In response to these demands, the local controller can control the converter (reactive power control), wind turbine (e.g. pitching, generator torque control) and/or solar panels (MPPT tracking) to meet the demands. Maximum power point tracking is a control of a solar panel to maximize its power output.

The local controllers can communicate their capability to generate active and reactive power to the park controller. The park controller can take these capabilities into account when distributing the active and reactive power demands within the park.

If the wind turbines are operating within the predetermined operational range, the reactive power capability is prioritized over the active power output. This means that at a moment in time, a relatively high reactive power demand is determined or received by the park control. This reactive power demand may be distributed within the park. At one or more of the hybrid machines, it may be necessary to curtail active power output in order to meet the reactive power demand. Curtailing active power output may be implemented by e.g. dissipating electricity generated by the solar panels, or non-optimal MPPT tracking of the solar panels.

If the wind turbines are not operating within the predetermined operational range, active power output may be prioritized over the reactive power output. The local controllers will send their limited capabilities to the park control, and the park control can take these capabilities into account when distributing reactive power commands. I.e. higher reactive power commands may be sent to hybrid machines that have the reactive power capability (e.g. because the wind turbines are operating).

Also, if an individual reactive power command is sent to a hybrid machine that is beyond the capabilities of the machine in that moment, the local controller may limit the reactive power demand to the amount of reactive power it can actually deliver.

If there is essentially no wind in the park and (almost) all wind turbines are inoperative, the active power output from the DC power sources (solar panels or other) can be prioritized. The reactive power output of the park can be limited and active power output can be maximized in order to provide frequency support of the grid. Occasionally, this could mean that an instantaneous reactive power demand from the grid cannot be met.

Throughout the present disclosure, specific reference has been made to (strings of) batteries to be used as energy storage. Non-limiting alternative examples of types of electrical energy storage devices include super capacitors, motor-generator systems, and magnetic energy storage systems.

Grid or “electrical grid” as used herein is meant to include any interconnected network for delivering electricity from power sources to utility distribution systems and/or loads.

Reference has herein been made to reactive power supply, reactive power demand, and reactive power capability or capacity. Reactive power as used herein should be understood to refer both to capacitive and to inductive reactive power.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application. If reference signs related to drawings are placed in parentheses in a claim, they are solely for attempting to increase the intelligibility of the claim, and shall not be construed as limiting the scope of the claim.

1. A hybrid power system (100) comprising:
a wind turbine (102) having a wind turbine generator and a power converter, and
one or more DC power sources (104), characterized in that
the hybrid power system is configured to prioritize active power output over reactive power capability when the wind turbine is not operating, and
is further configured to prioritize reactive power capability over active power output when the wind turbine is operating and wind speed is above a predetermined threshold.

2-15. (canceled)
